(19) United States
(12) Patent Application Publication
(10) Pub. No.: US 2008/0117513 A1
(43) Pub. Date: May 22, 2008

(54) TWO-LAYERED OPTICAL PLATE AND METHOD FOR MAKING THE SAME

(75) Inventors: TUNG-MING HSU, Tu-Cheng (TW); SHAO-HAN CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/684,469

(22) Filed: Mar. 9, 2007

(30) Foreign Application Priority Data
Nov. 20, 2006 (CN) 200610201114.8

(51) Int. Cl. G02B 5/02; B29D 11/00

(52) U.S. Cl. 359/599; 264/1.29

(57) ABSTRACT

An exemplary optical plate (20) includes a transparent layer (21) and a light diffusion layer (23). The transparent layer includes a light input interface (211), a light output surface (213) opposite to the light input interface, and plural elongated protrusions (215) defined at the light output surface (213). Each two adjacent elongated protrusions (215) cooperatively define a trough therebetween. At least one of a top portion of each of the elongated protrusions and a bottom portion of each of the troughs is curved. The light diffusion layer is integrally formed with the transparent layer adjacent to the light input interface. The light diffusion layer includes a transparent matrix resins (231) and plural diffusion particles (233) dispersed in the transparent matrix resins. A method for making the optical plate is also provided.

### CROSS-REFERENCE TO RELATED APPLICATIONS

This application is related to eight copending U.S. patent applications, which are: application Ser. No. 11/655,430, filed on Jan. 19, 2007, and entitled “TWO-LAYERED OPTICAL PLATE AND METHOD FOR MAKING THE SAME”; application Ser. No. 11/655,426, filed on Jan. 19, 2007, and entitled “TWO-LAYERED OPTICAL PLATE AND METHOD FOR MAKING THE SAME”; application Ser. No. 11/655,431, filed on Jan. 19, 2007, and entitled “TWO-LAYERED OPTICAL PLATE AND METHOD FOR MAKING THE SAME”; application Ser. No. 11/655,425, filed on Jan. 19, 2007, and entitled “TWO-LAYERED OPTICAL PLATE AND METHOD FOR MAKING THE SAME”; application Ser. No. ______ (US Docket No. US12508), filed on Feb. 9, 2007, and entitled “TWO-LAYERED OPTICAL PLATE AND METHOD FOR MAKING THE SAME”; application Ser. No. ______ (US Docket No. US12507), filed on Feb. 9, 2007, and entitled “TWO-LAYERED OPTICAL PLATE AND METHOD FOR MAKING THE SAME”; application Ser. No. ______ (US Docket No. US11887), filed on Mar. 2, 2007, and entitled “TWO-LAYERED OPTICAL PLATE AND METHOD FOR MAKING THE SAME”; and application Ser. No. ______ (US Docket No. US11888), filed on Mar. 2, 2007, and entitled “TWO-LAYERED OPTICAL PLATE AND METHOD FOR MAKING THE SAME”. In all these copending applications, the inventor is Tung-Ming Hsu et al. All of the copending applications have the same assignee as the present application. The disclosures of the above identified applications are incorporated herein by reference.

### BACKGROUND OF THE INVENTION

1. Field of the Invention

The present invention generally relates to optical plates and methods for making optical plates, and more particularly to an optical plate for use in apparatus such as a backlight module of a liquid crystal display (LCD).

2. Discussion of the Related Art

The lightness and slimness of LCD panels make them suitable for a wide variety of uses in electronic devices such as mobile phones, personal digital assistants (PDAs), portable personal computers, and other electronic appliances. Liquid crystal is a substance that cannot emit light by itself; instead, the liquid crystal needs to receive light from a light source in order to display data and images. In the case of a typical LCD panel, a backlight module powered by electricity supplies the needed light.

FIG. 8 is an exploded, side cross-sectional view of a typical backlight module 10 employing a typical optical diffusion plate. The backlight module 10 includes a housing 11, a plurality of lamps 12 disposed above a base of the housing 11, and a light diffusion plate 13 and a prism sheet 14 stacked on top of the housing 11 in that order. The lamps 12 emit light, and inside walls of the housing 11 are configured for reflecting light towards the light diffusion plate 13. The light diffusion plate 13 includes a plurality of embedded diffusion particles. The diffusion particles are configured for scattering received light, and thereby enhancing the uniformity of light that exits the light diffusion plate 13. The prism sheet 14 includes a plurality of V-shaped structures on a top thereof. The V-shaped structures are configured for collimating received light to a certain extent.

In use, light emitting from the lamps 12 enters the prism sheet 14 after being scattered in the diffusion plate 13. The light is refracted by the V-shaped structures of the prism sheet 14 and is thereby concentrated so as to increase brightness of light illumination. Finally, the light propagates into an LCD panel (not shown) disposed above the prism sheet 14. Although the brightness may be improved by the V-shaped structures of the prism sheet 14, the viewing angle may be narrow. In addition, the diffusion plate 13 and the prism sheet 14 are in contact with each other, but with a plurality of air pockets still existing at the boundary between them. When the backlight module 10 is in use, light passes through the air pockets, and some of the light undergoes total reflection at the air pockets. As a result, a light energy utilization ratio of the backlight module 10 is reduced.

Therefore, a new optical means is desired in order to overcome the above-described shortcomings. A method for making such optical means is also desired.

### SUMMARY

In one aspect, an optical plate includes a transparent layer and a light diffusion layer. The transparent layer includes a light input interface, a light output surface on an opposite side of the transparent layer to the light input interface, and a plurality of elongated protrusions defined at the light output surface. Each two adjacent elongated protrusions cooperatively define a trough therebetween, and at least one of a top portion of each of the elongated protrusions and a bottom portion of each of the troughs is curved. The light diffusion layer is integrally formed with the transparent layer in immediate contact with the light input interface of the transparent layer. The light diffusion layer includes a transparent matrix resin, and a plurality of diffusion particles dispersed in the transparent matrix resin.

In another aspect, a method for making at least one optical plate includes: heating a first transparent matrix resin to a melted state; heating a second transparent matrix resin to a melted state; injecting the melted first transparent matrix resin into a first molding chamber of a two-shot injection mold to form a transparent layer of the at least one optical plate, the two-shot injection mold including a female mold and at least one male mold, the female mold defining at least one molding cavity receiving the at least one male mold, the female mold including a plurality of elongated protrusions formed at an inmost end of the at least one molding cavity, and each two adjacent elongated protrusions cooperatively define a trough therebetween, and at least one of a top portion of each of the elongated protrusions and a bottom portion of each of the troughs is curved, a portion of the at least one molding cavity and the at least one male mold cooperatively forming the first molding chamber; moving the at least one male mold a distance away from the inmost end of the at least one molding cavity of the female mold; injecting the melted second transparent matrix resin into a second molding chamber of the two-shot injection mold to form a light diffusion layer of the at least one optical plate on the transparent layer, a portion of the at least one molding cavity, the transparent layer, and the at least one male mold cooperatively forming the second molding chamber; and taking the combined transparent layer and light diffusion layer out of the at least one molding cavity of the female mold.

In still another aspect, a method for making an optical plate includes: heating a first transparent matrix resin to a melted state; heating a second transparent matrix resin to a melted state; injecting the melted first transparent matrix resin into a first molding chamber of a two-shot injection mold to form a light diffusion layer of the optical plate, the two-shot injection mold including a female mold and two male molds, the female mold defining a molding cavity receiving a first one of the male molds, a portion of the molding cavity and the first male mold cooperatively forming the first molding chamber; withdrawing the first male mold from the female mold; injecting the melted second transparent matrix resin into a second molding chamber of the two-shot injection mold to form a transparent layer of the optical plate on the light diffusion layer, the molding cavity of the female mold receiving the second one of the male molds, the second male mold including a plurality of elongated protrusions formed at a molding surface thereof, each two adjacent elongated protrusions cooperatively defining a trough, at least one of a top portion of each of the elongated protrusions and a bottom portion of each of the troughs being curved, and a portion of the molding cavity, the light diffusion layer, and the second male mold cooperatively forming the second molding chamber; and taking the combined light diffusion layer and transparent layer out of the molding cavity of the female mold.

Other novel features and advantages will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating principles of the present optical plate and method. Moreover, in the drawings, like reference numerals designate corresponding parts throughout various views, and all the views are schematic.

FIG. 1 is an isometric view of an optical plate in accordance with a first embodiment of the present invention.

FIG. 2 is a side cross-sectional view taken along line II-II of FIG. 1.

FIG. 3 is a side cross-sectional view of an optical plate in accordance with a second embodiment of the present invention.

FIG. 4 is a side cross-sectional view of an optical plate in accordance with a third embodiment of the present invention.

FIG. 5 is a side cross-sectional view of a two-shot injection mold used in an exemplary method for making the optical plate of FIG. 1, showing formation of a transparent layer of the optical plate.

FIG. 6 is similar to FIG. 5, but showing subsequent formation of a diffusion layer of the optical plate on the transparent layer, and showing simultaneous formation of a transparent layer of a second optical plate.

FIG. 7 is a side cross-sectional view of another two-shot injection mold used in another exemplary method for making the optical plate of FIG. 1.

FIG. 8 is an exploded, side cross-sectional view of a conventional backlight module.

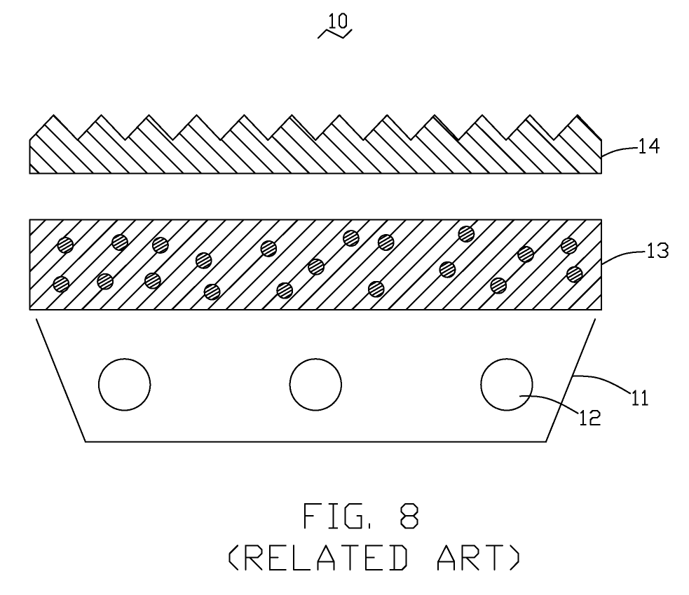

### DETAILED DESCRIPTION OF THE EMBODIMENTS

Reference will now be made to the drawings to describe preferred embodiments of the present optical plate and method for making the optical plate in detail.

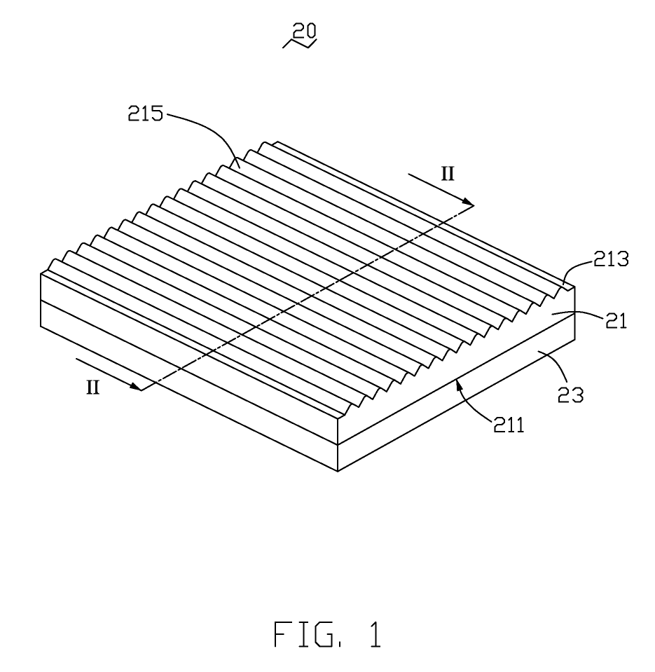

Referring to FIG. 1, an optical plate 20 according to a first embodiment is shown. The optical plate 20 includes a transparent layer 21 and a light diffusion layer 23. The transparent layer 21 and light diffusion layer 23 are integrally formed. That is, the transparent layer 21 and light diffusion layer 23 are in immediate contact with each other at a common interface between them. The transparent layer 21 includes a light input interface 211, a light output surface 213 on an opposite side of the transparent layer 21 to the light input interface 211, and a plurality of elongated protrusions 215 defined at the light output surface 213. The light diffusion layer 23 is located adjacent the light input interface 211 of the transparent layer 21. The elongated protrusions 215 are configured for collimating light emitting out of the optical plate 20, thus improving the brightness of light illumination. The elongated protrusions 215 are aligned side by side at the light output surface 213 of the transparent layer 21, and are parallel to each other. Each of the elongated protrusions 215 extends along a direction parallel to a side surface of the optical plate 20. Alternatively, an angle defined between a side surface of the optical 20 and each of the elongated protrusions 215 can be in a range from more than 0 degrees to less than 90 degrees. In the illustrated embodiment, a top portion of each elongated protrusion 215 is curved. Each two adjacent elongated protrusions 215 cooperatively define a trough therebetween. A bottom portion of each trough (not labeled) is dihedral. That is, the bottom portion of the trough is defined by two intersecting planes of the two elongated protrusions 215.

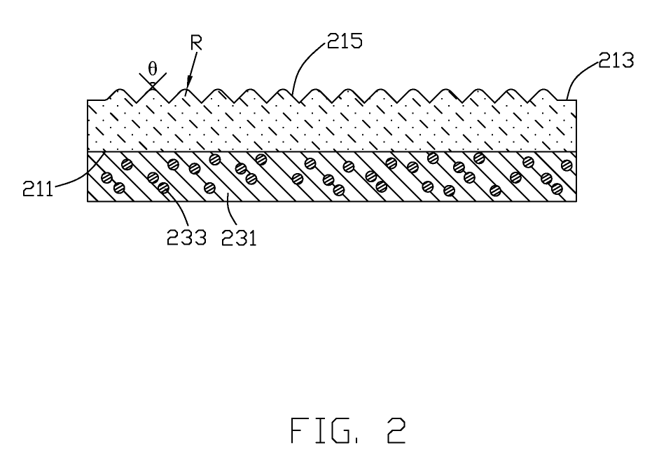

Referring also to FIG. 2, to achieve high quality optical effects, a pitch between adjacent elongated protrusions 215 is preferably in a range from about 0.025 millimeters to about 1.5 millimeters. A radius R of an arc defined by the curve of the top portion of each elongated protrusion 215 is in a range from more than 0 millimeters to 0.55 millimeters. A dihedral angle θ defined by planes of two sides of each elongated protrusion 215 is in a range from 60 degrees to 120 degrees.

The light diffusion layer 23 includes a transparent matrix resin 231, and a plurality of diffusion particles 233 dispersed in the transparent matrix resin 231. A thickness of the transparent layer 21 and a thickness of the light diffusion layer 23 can each be equal to or greater than 0.35 millimeters. In the illustrated embodiment, a combined thickness of the transparent layer 21 and the light diffusion layer 23 is preferably in a range from 1 millimeter to 6 millimeters. The transparent layer 21 can be made of one or more transparent matrix resins selected from the group consisting of polymethyl methacrylate, polycarbonate, polystyrene, methyl methacrylate and styrene copolymer, and any combination thereof. In addition, the light input interface 211 of the transparent layer 21 can either be a flat interface or a rough interface.

The light diffusion layer 23 preferably has a light transmission ratio in a range from 30% to 98%. The light diffusion layer 23 is configured for enhancing uniformity of light output from the optical plate 20. The transparent matrix resin 231 can be one or more resins selected from the group consisting of polymethyl methacrylate, polycarbonate, polystyrene, methyl methacrylate and styrene copolymer, and any combination thereof. The diffusion particles 233 can be made of material selected from the group consisting of titanium dioxide, silicon dioxide, acrylic resin, and any combination thereof. The diffusion particles 233 are configured for scattering light and enhancing a light distribution capability of the light diffusion layer 23.

When the optical plate 20 is utilized in a typical backlight module, light emitting from lamp tubes (not shown) of the backlight module enter the light diffusion layer 23 of the optical plate 20. The light is substantially diffused in the light diffusion layer 23. Subsequently, the diffused light is concentrated by the elongated protrusions 215 of the optical plate 20 before exiting the light output surface 213. As a result, a brightness of the backlight module is increased. In addition, the transparent layer 21 and the light diffusion layer 23 are integrally formed together, with no air or gas pockets trapped therebetween. Therefore little or no back reflection occurs at the common interface, and an efficiency of utilization of light is increased. Furthermore, when the optical plate 20 is utilized in a backlight module, it can in effect replace a conventional combination of a diffusion plate and a prism sheet. Thereby, a process of an assembly of the backlight module is simplified. Moreover, the volume occupied by the optical plate 20 is generally less than that occupied by the combination of the diffusion plate and the prism sheet. Thereby, the volume of the backlight module is reduced. Still further, the single optical plate 20 instead of the combination of two optical plates/sheets can reduce costs.

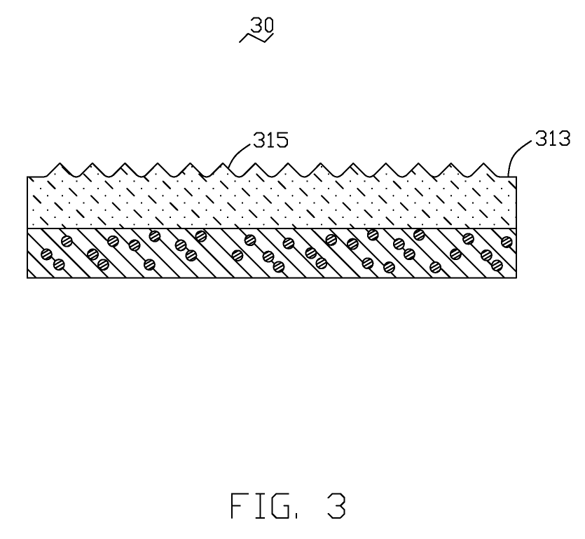

Referring to FIG. 3, an optical plate 30 according to a second embodiment is shown. The optical plate 30 is similar in principle to the optical plate 20 described above. However, the optical plate 30 includes a plurality of elongated protrusions 315 at a light output surface 313. A top portion of each elongated protrusion 315 is dihedral. That is, the top portion of the elongated protrusion 315 is defined by two intersecting planes of the elongated protrusion 315. A dihedral angle (not labeled) defined by the planes of two sides of each elongated protrusion 315 is in a range from 60 degrees to 120 degrees. Moreover, a bottom portion of each of troughs (not labeled) is curved. In particular, a radius of an arc defined by the curve of the bottom portion of each trough can be in a range from more than 0 millimeters to 0.55 millimeters.

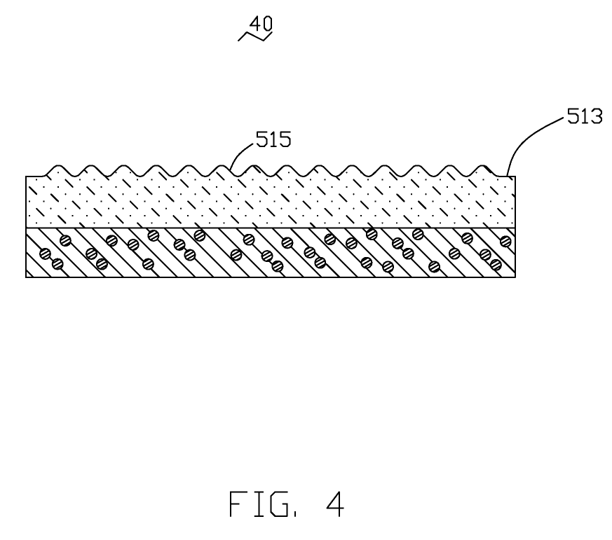

Referring to FIG. 4, an optical plate 40 according to a third embodiment is shown. The optical plate 40 is similar in principle to the optical plates 20, 30 described above. However, the optical plate 40 includes a plurality of elongated protrusions 515 defined at a light output surface 513. A top portion of each elongated protrusion 515 and a bottom portion of each of troughs are both curved.

An exemplary method for making any of the above-described optical plates 20, 30, 40 will now be described. The optical plate 20, 30, 40 is made using a two-shot injection technique. The optical plate 20 of the first embodiment is taken here as an exemplary application, for the purposes of conveniently describing details of the exemplary method.

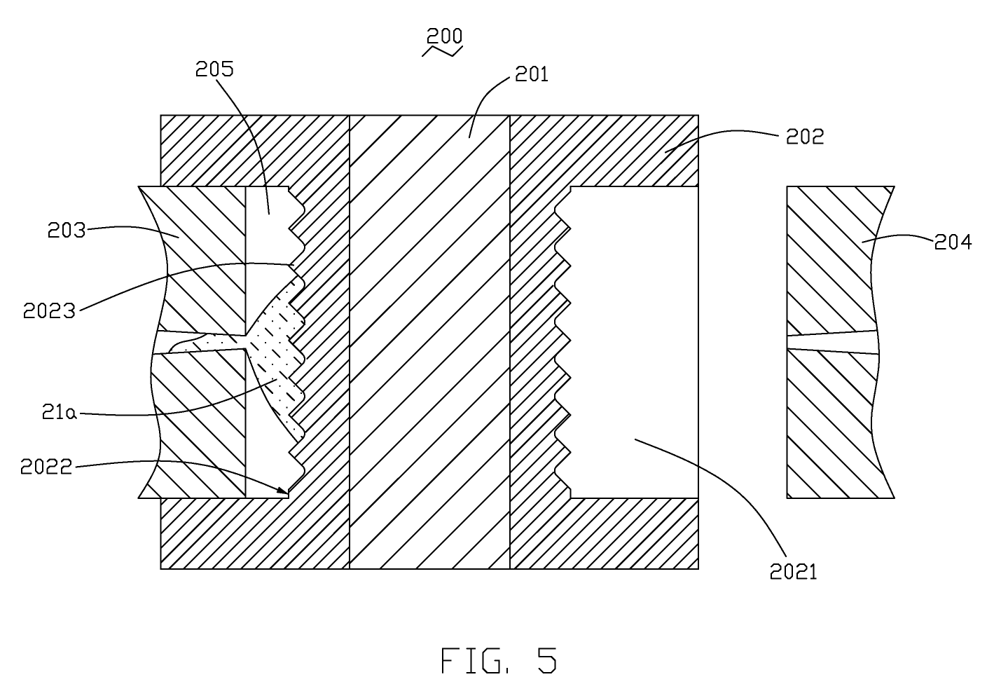

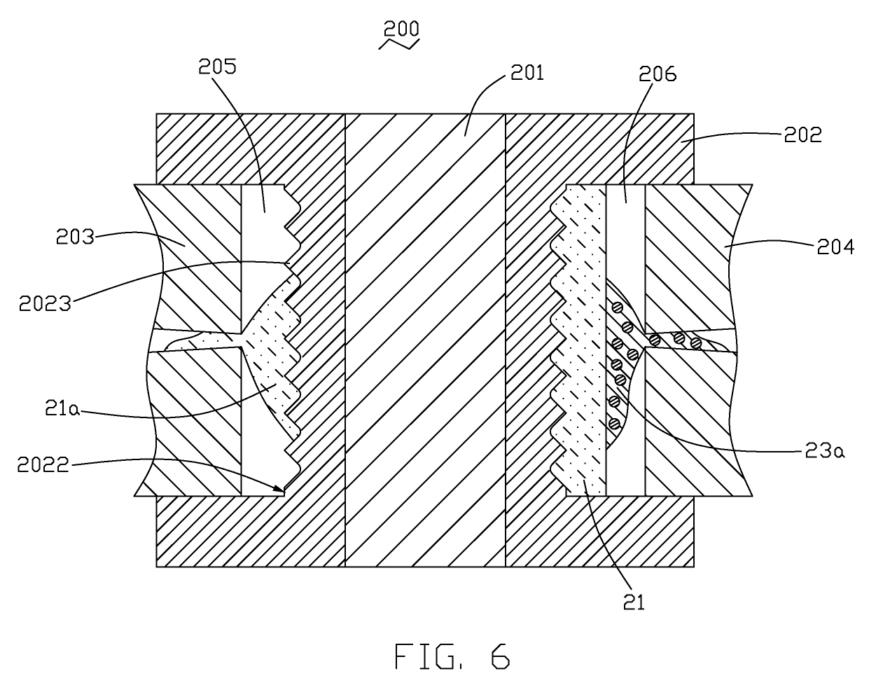

Referring to FIGS. 5 and 6, a two-shot injection mold 200 is provided for making the optical plate 20. The two-shot injection mold 200 includes a rotatable device 201, a first mold 202 functioning as two female molds, a second mold 203 functioning as a first male mold, and a third mold 204 functioning as a second male mold. The first mold 202 defines two molding cavities 2021, and includes an inmost surface 2022 at an inmost end of each of the molding cavities 2021. A plurality of elongated protrusions 2023 are formed at each of the inmost surface 2022. Each two adjacent elongated protrusions 2023 cooperatively define a trough therebetween, and a bottom portion of each trough is curved. In the illustrated embodiment, each trough has a shape corresponding to that of each elongated protrusion 215 of the optical plate 20.

In a molding process, a first transparent matrix resin 21a is melted. The first transparent matrix resin 21a is for making the transparent layer 21. A first one of the molding cavities 2021 of the first mold 202 slidably receives the second mold 203, so as to form a first molding chamber 205 for molding the first transparent matrix resin 21a. Then, the melted first transparent matrix resin 21a is injected into the first molding chamber 205. After the transparent layer 21 is formed, the second mold 203 is withdrawn from the first molding cavity 2021. The first mold 202 is rotated about 180 degrees in a first direction. A second transparent matrix resin 23a is melted. The second transparent matrix resin 23a is for making the light diffusion layer 23. The first molding cavity 2021 of the first mold 202 slidably receives the third mold 204, so as to form a second molding chamber 206 for molding the second transparent matrix resin 23a. Then, the melted second transparent matrix resin 23a is injected into the second molding chamber 206. After the light diffusion layer 23 is formed, the third mold 204 is withdrawn from the first molding cavity 2021. The first mold 202 is rotated further in the first direction, for example about 90 degrees, and a solidified combination of the transparent layer 21 and the light diffusion layer 23 is removed from the first molding cavity 2021. In this way, the optical plate 20 is formed using the two-shot injection mold 200.

As shown in FIG. 6, when the light diffusion layer 23 is being formed in the first molding cavity 2021, simultaneously, a transparent layer 21 for a second optical plate 20 can be formed in the second one of the molding cavities 2021. Once the first optical plate 20 is removed from the first molding cavity 2021, the first mold 202 is rotated still further in the first direction about 90 degrees back to its original position. Then the first molding cavity 2021 slidably receives the second mold 203 again, and a third optical plate 20 can begin to be made in the first molding chamber 205. Likewise, the second molding cavity 2021 having the transparent layer 21 for the second optical plate 20 slidably receives the third mold 204, and a light diffusion layer 23 for the second optical plate 20 can begin to be made in the second molding chamber 206.

In an alternative embodiment of the above-described molding process(es), after the third mold 204 is withdrawn from the first molding cavity 2021, the first mold 202 can be rotated in a second direction opposite to the first direction. For example, the first mold 202 can be rotated about 90 degrees in the second direction. Then the solidified combination of the transparent layer 21 and the light diffusion layer 22 is removed from the first molding cavity 2021, such solidified combination being the first optical plate 20. Then once the first optical plate 20 has been removed from the first molding cavity 2021, the first mold 202 is rotated further in the second direction about 90 degrees back to its original position.

The transparent layer 21 and light diffusion layer 23 of each optical plate 20 are integrally formed by the two-shot injection mold 200. Therefore no air or gas is trapped between the transparent layer 21 and light diffusion layer 23. Thus the common interface between the two layers 21, 22 provides for maximum unimpeded passage of light.

It should be understood that the first optical plate 20 can be formed using only one female mold, such as that of the first mold 202 at the first molding cavity 2021 or the second molding cavity 2021, and one male mold, such as the second mold 203 or the third mold 204. For example, a female mold such as that of the first molding cavity 2021 can be used with a male mold such as the second mold 203. In this kind of embodiment, the transparent layer 21 is first formed in a first molding chamber cooperatively formed by the male mold moved to a first position and the female mold. Then the male mold is separated from the transparent layer 21 and moved a short distance to a second position. Thus a second molding chamber is cooperatively formed by the male mold, the female mold, and the transparent layer 21. Then the light diffusion layer 23 is formed on the transparent layer 21 in the second molding chamber.

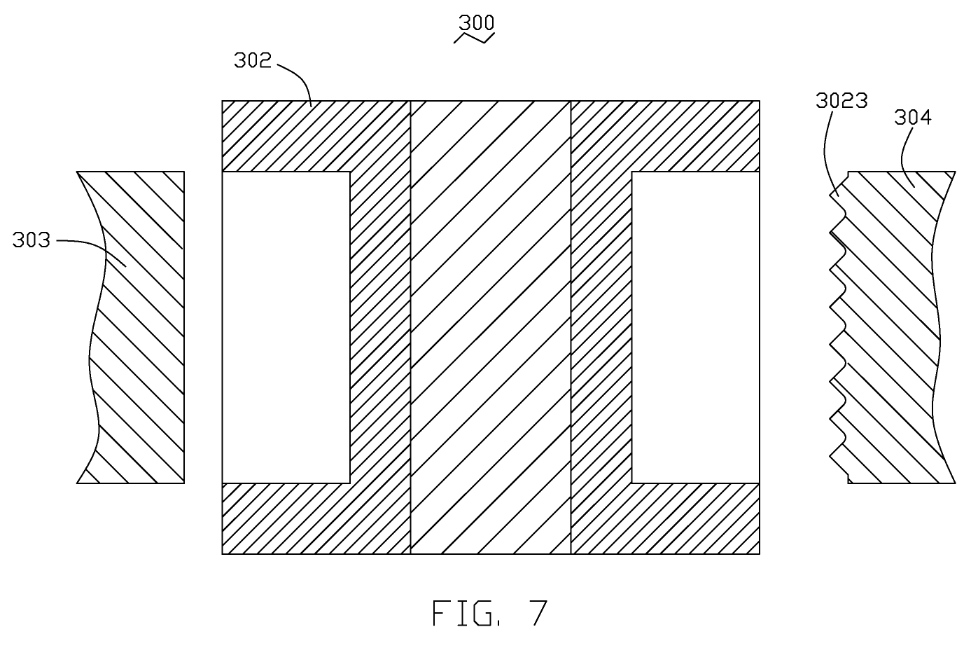

Referring to FIG. 7, in an alternative exemplary method, a two-shot injection mold 300 is used for making any of the above-described optical plates 20, 30, 40. The optical plate 20 of the first embodiment is taken here as an exemplary application, for the purposes of conveniently describing details of the alternative exemplary method. The two-shot injection mold 300 is similar in principle to the two-shot injection mold 200 described above. However, the two-shot injection mold 300 includes a first mold 302, a second mold 303, and a third mold 304. The third mold 304 functions as a second male mold. A plurality of elongated protrusions 3023 are formed at a molding surface of the third mold 304. Each two adjacent elongated protrusions 3023 cooperatively define a trough therebetween, and a bottom portion of each trough is curved. Each trough has a shape corresponding to that of each elongated protrusion 215 of the optical plate 20. In the method for making the optical plate 20 using the two-shot injection mold 300, firstly, a first melted transparent matrix resin is injected into a first molding chamber formed by the second mold 303 and the first mold 302, so as to form the light diffusion layer 23. Then, the first mold 302 is rotated 180 degrees in a first direction. The first mold 302 slidably receives the third mold 304, so as to form a second molding chamber. A second melted transparent matrix resin is injected into the second molding chamber, so as to form the transparent layer 21 on the light diffusion layer 23.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. An optical plate, comprising:
a transparent layer comprising a light input interface, a light output surface on an opposite side of the transparent layer to the light input interface, and a plurality of elongated protrusions at the light output surface, wherein each two adjacent elongated protrusions cooperatively define a trough therebetween, and at least one of a top portion of each elongated protrusion and a bottom portion of each trough is curved; and
a light diffusion layer integrally formed in immediate contact with the light input interface of the transparent layer by two-shot injection molding, the light diffusion layer including a transparent matrix resin and a plurality of diffusion particles dispersed in the transparent matrix resin.

2. The optical plate as claimed in claim 1, wherein each of a thickness of the transparent layer and a thickness of the light diffusion layer is equal to or greater than 0.35 millimeters.

3. The optical plate as claimed in claim 1, wherein a radius of an arc defined by the curve of the top portion of each elongated protrusion is in the range from more than 0 millimeters to 0.55 millimeters.

4. The optical plate as claimed in claim 1, wherein a radius of an arc defined by the curve of the bottom portion of each trough is in the range from more than 0 millimeters to 0.55 millimeters.

5. The optical plate as claimed in claim 1, wherein a pitch between adjacent elongated protrusions is in the range from about 0.025 millimeters to about 1.5 millimeters.

6. The optical plate as claimed in claim 1, wherein the transparent matrix resin is selected from the group consisting of polymethyl methacrylate, polycarbonate, polystyrene, methyl methacrylate and styrene copolymer, and any combination thereof.

7. The optical plate as claimed in claim 1, wherein the diffusion particles are made of one or more materials selected from the group consisting of titanium dioxide, silicon dioxide, acrylic resin, and any combination thereof.

8. The optical plate as claimed in claim 1, wherein a dihedral angle θ defined by planes of two sides of each elongated protrusion is in the range from 60 degrees to 120 degrees.

9-16. (canceled)

17. An optical plate, comprising:
a transparent layer comprising a light input interface, a light output surface on an opposite side of the transparent layer to the light input interface, and a plurality of elongated protrusions at the light output surface, wherein each two adjacent elongated protrusions cooperatively define a trough therebetween, and at least one of a top portion of each elongated protrusion and a bottom portion of each trough is curved; and
a light diffusion layer integrally formed in immediate contact with the light input interface of the transparent layer by two-shot injection molding, the light diffusion layer including a transparent matrix resin and a plurality of diffusion particles dispersed in the transparent matrix resin, wherein the light diffusion layer has a light transmission ratio in the range from 30% to 98%.
